(19) United States
(12) Patent Application Publication
(10) Pub. No.: US 2026/0080764 A1
(43) Pub. Date: Mar. 19, 2026

(54) FIRE DETECTION SYSTEM

(71) Applicant: Think Circuits, LLC, Lafayette, CA (US)

(72) Inventors: Kevin Weekly, Lafayette, CA (US); Chris Sarantos, San Francisco, CA (US); David Burnett, Portland, OR (US); Michael Pihulic, South San Francisco, CA (US); Perry Scott, New York, NY (US)

(21) Appl. No.: 19/330,609

(22) Filed: Sep. 16, 2025

Related U.S. Application Data
(60) Provisional application No. 63/695,637, filed on Sep. 17, 2024.

(51) Int. Cl. G08B 17/12; G06V 10/82

(52) U.S. Cl. CPC G08B 17/125; G06V 10/82

(57) ABSTRACT

A fire detection system is provided. The system includes camera(s), focusing elements such as lenses or mirrors, and filters. The camera(s) collect images, some through at least a first filter of the filters, and some through at least a second filter of the filters. By comparing the images, fires may be detected. For instance, the filters may be selected so that one filter selects for light at a frequency associated with emissions from fires and so that another filter selects for light at another frequency. By comparing images collected through the different filters, a presence or absence of a fire may be determined.

### CROSS-REFERENCE TO RELATED APPLICATIONS

This patent application is a non-provisional application that claims priority to U.S. Provisional Patent App. No. 63/695,637 entitled “FIRE DETECTION SYSTEM” filed Sep. 17, 2024, which is incorporated by reference herein in its entirety.

### BACKGROUND

### 1. Field

The various aspects and embodiments described herein relate to fire detection systems, and more specifically, to optical fire detection systems.

### 2. Description of the Related Art

Fire detection systems, such as outdoor fire detection systems, and in particular, optical outdoor fire detection systems, involve heavy, complex, and/or expensive hardware. For instance, extant systems include high resolution spectrometry. However, a high resolution spectrometer may be expensive, may require significant data processing, and may be of relatively low spatial resolution. Moreover, such systems often require sweeping of imaging equipment in space to collect light across a spectrum, then stitching together of data. In various instances, short wave infrared may be implemented, however, the physical geometry of these sensors may be challenging and the equipment may be expensive. In other systems, thermal cameras such as long wave infrared (LWIR) systems present expensive and power-hungry alternatives which often have poor resolution. Thus there remains a need for lower cost and higher performance fire detection systems.

### SUMMARY

A fire detection system may include a camera system. The camera system may have at least one camera having an associated at least one optical path. The fire detection system may include a focusing system. The focusing system may include at least one focusing element such as a lens, mirror, or other focusing element in the at least one optical path of the at least one camera. The fire detection system may include a filter system. The filter system may include at least (i) a first filter having a first center frequency and first passband and (ii) a second filter having a second center frequency and second passband. Moreover, the fire detection system may include a controller. The controller may be configured to compare (iii) a first image captured by the camera system through the at least one optical path including the first filter and not the second filter and (iv) a second image captured by the camera system through the at least one optical path including the second filter and not the first filter, to determine a presence or absence of a fire.

In various embodiments, the first center frequency is 770 nm and the second center frequency is 810 nm. In various embodiments, the first passband and the second passband have same bandwidth. In various embodiments, the first center frequency and first passband are associated with a first spectral range between 760 and 780 nm and the second center frequency and second passband are associated with a reference band within plus or minus 40 nm of the first spectral range. In various embodiments, the first filter and the second filter are filter elements of a same filter, the filter elements affecting different pixels in a sensor focalplane of a same camera of the camera system.

A further fire detection system is offered. The system may include a first camera. The system may include a first focusing element in a first optical path of the first camera. The system may include a first filter and a second filter. In various embodiments, the first filter and the second filter are insertable into the first optical path. The fire detection system may include a controller connected to the first camera and configured to capture a first image by the first camera through the first focusing element and the first filter and configured to capture a second image by the first camera through the first focusing element and the second filter. A presence of a fire is detectable by comparing the first image and the second image, such as by the controller.

In various embodiments, the first filter and the second filter are selectably insertable by an actuator into the first optical path. In various embodiments, the first filter and the second filter comprise different filter elements of a same filter, the different filter elements affecting different pixels of a sensor focalplane of the first camera. In various embodiments, the first filter has a first center frequency of 770 nm and the second filter has a second center frequency of 810 nm.

A yet further fire detection system is contemplated. The system may include a first camera. The system may include a second camera. The system may include a first focusing element in a first optical path of the first camera. The system may include a second focusing element in a second optical path of the second camera. The system may include a first filter in the first optical path of the first camera. The system may include a second filter in the second optical path of the second camera. In various embodiments, the first camera and the second camera are connectable to a controller such as a fire detection controller for detecting a fire.

The system may include the controller so that the fire detection controller is connected to the first camera and the second camera and configured to compare a first image collected by the first camera through the first optical path and a second image collected by the second camera through the second optical path.

In various embodiments, the first filter has a first center frequency of 770 nm and the second filter has a second center frequency of 810 nm.

A method of fire detection is provided. The method may be a method of fire detection by a fire detection system comprising (a) a camera system comprising at least one camera having an associated at least one optical path; (b) a focusing system comprising at least one focusing element in the at least one optical path of the at least one camera; (c) a filter system comprising at least (i) a first filter having a first center frequency and first passband and (ii) a second filter having a second center frequency and second passband; and (d) a controller. The method may include detecting by the camera system a first image captured by the camera system through the at least one optical path including the first filter and not the second filter. The method may include detecting by the camera system a second image captured by the camera system through the at least one optical path including the second filter and not the first filter. The method may include comparing, by the controller, the first image and the second image. The method may include determining, by the controller, a presence or absence of a fire, wherein the presence of the fire corresponds to a difference existing between the first image and the second image, and wherein an absence of the fire corresponds to a similarity existing between the first image and the second image. In various embodiments of the method, the controller includes an artificial intelligence engine having a plurality of neural nets configured to perform the determining. In various embodiments, the first filter and the second filter are filter elements of a same filter, the filter elements affecting different pixels in a sensor focalplane of a same camera of the camera system.

A fire detection system may include a camera system. The camera system may have at least one camera having an associated at least one optical path. The fire detection system may include a focusing system. The focusing system may include at least one focusing element such as a lens, mirror, or other focusing element in the at least one optical path of the at least one camera. The fire detection system may include a filter system. The filter system may include at least (i) a first filter having a first center frequency and first passband and (ii) a second filter having a second center frequency and second passband. Moreover, the fire detection system may include a controller. The controller may be configured to compare (iii) a first image captured by the camera system through the at least one optical path including the first filter and not the second filter and (iv) a second image captured by the camera system through the at least one optical path including the second filter and not the first filter, to determine a presence or absence of a fire. The fire detection system may at least one of (1) further includes and (2) is in electronic communication with a further camera, and the controller performs sensor fusion with data corresponding to an additional optical band of the further camera.

In various embodiments, the further camera is a longwave infrared camera. In various embodiments, the further camera is a medium wave infrared camera. The further camera may be a short wave infrared (SWIR) camera. In various embodiments, the first filter and the second filter are filter elements of a same filter, the filter elements affecting different pixels in a sensor focalplane of a same camera of the camera system.

A further fire detection system is offered. The system may include a first camera. The system may include a first focusing element in a first optical path of the first camera. The system may include two or more spectral filters affecting different pixels at the focalplane of the camera where the CMOS sensor is located, such that one set of pixels receives light filtered by the first filter and one set of pixels receives light filtered by the second filter. These filters at the focalplane may either be arranged in repeating mosaic blocks as in a Bayer filter, or in horizontal or vertical stripes as in a push-broom style filter.

### BRIEF DESCRIPTION OF THE DRAWINGS

Other apparatus, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

FIGS. 1A-1B illustrate example block diagrams of a fire detection system, in accordance with various embodiments;

FIG. 2 illustrates an example embodiment of a fire detection system having a first optical path with a filter system having multiple filters movable by an actuator, in accordance with various embodiments;

FIG. 3 illustrates an example embodiment of a fire detection system having a first optical path having a first filter and a second optical path having a second filter, in accordance with various embodiments;

FIG. 4 illustrates a further example embodiment of a fire detection system having a first optical path with a filter system having multiple filters movable by an actuator, in accordance with various embodiments;

FIG. 5 illustrates a further embodiment of a fire detection system having a first optical path having a first filter and a second optical path having a second filter, in accordance with various embodiments;

FIG. 6 illustrates a graph of an example emission spectrum of a fire, in accordance with various embodiments;

FIG. 7 provides an example illustration of an example enclosure for a fire detection system, in accordance with various embodiments;

FIG. 8 provides a further example illustration of an example enclosure for a fire detection system, in accordance with various embodiments;

FIGS. 9 and 10 show an example embodiment of a system having a first optical path and a second optical path, with a controller, mounted together in a compact package, in accordance with various embodiments;

FIG. 11 shows an example embodiment of a system in an enclosure of FIGS. 7 and 8 and showing the first optical path and the second optical path, in accordance with various embodiments; and

FIG. 12 illustrates a method of fire detection, in accordance with various embodiments.

### DETAILED DESCRIPTION

Fire detection systems involve heavy, complex, and/or expensive hardware. For instance, extant systems include high resolution spectrometry. However, a high resolution spectrometer may be expensive, may require significant data processing, and may be of relatively low spatial resolution. Moreover, such systems often require sweeping of imaging equipment in space to collect light across a spectrum, then stitching together of data. In various instances, short wave infrared may be implemented, however, the physical geometry of these sensors may be challenging and the equipment may be expensive. Thus there remains a need for lower cost and higher performance fire detection systems.

Also, existing systems may exhibit limited performance. For instance, use of long-wave infrared to identify heat signatures is expensive and requires a trained operator. Many such systems are liquid cooled. Many include complex Stirling-Acoustic engines. Many such systems are low resolution and frequently direct attention to hot things that are not fires.

The system disclosed herein provides for higher resolution and higher frame rate imaging, as well as automated fire detection capabilities. In various embodiments, images are collected through different filters. For example, images collected through a filter having a center frequency of about 810 nm provides a reference image. Images collected through a filter having a center frequency of about 770 nm include light corresponding to the potassium emission spectrum. Many fires, such as wildfires, include significant emission at or about 770 nm, as the relative irradiance of a fire having organic fuel often corresponds to potassium emissions associated with potassium in the fuel. Moreover, by having a reference image through a filter having the center frequency of about 810 nm, atmospheric noise often manifests as common-mode noise and is similar in images through each of the filters. In this manner, atmospheric noise may be ameliorated and also accuracy of fire location determinations improved. Moreover, sunlight effects from reflection from foliage is similar at both 770 nm and 810 nm, further ameliorating common mode noise in outdoor environments. Yet furthermore, 770 nm facilitates imaging through smoke, as longer wavelengths typically penetrate smoke better than short wavelengths. Yet furthermore, these frequencies coincide with near-IR CMOS sensor capabilities, such as commodity sensors for security systems, as well as available filter architectures.

Other filters are also contemplated. For instance, different center frequencies may correspond to the detection of different types of burning chemicals. For example, filters may be selected to identify burning sodium compounds such as sodium nitrate. Such filters may have a center frequency of about 590 nm. Filters may be selected to identify burning calcium compounds such as calcium nitrate. Such filters may have a center frequency of about 620 nm and/or about 550 nm. Filters may be selected to identify burning phosphorous compounds. For instance, filters may have a center frequency of about 350-400 nm for P, 400-450 nm for P2, and/or 500-600 nm for PO). Filters may be selected at low spots in the reflectance spectrum of live plant leaves, which may peak at green and NIR above ˜720, but are also more within the range of manmade lights. Moreover, the ranges for different filters may be different. Ranges herein may refer to frequency ranges or wavelength ranges.

The systems and methods enable many different capabilities in addition to fire detection. For instance, these systems and methods facilitate providing of estimates of a destructive potential of a fire. These systems and methods facilitate guiding firefighters and firefighting prioritization. For example, these systems and methods facilitate estimating the size and directions of spread of the fire, and integrating local weather data (wind, cumulative rainfall over the year, humidity, etc) as well as maps of nearby populated areas, elevation maps, other geographical information systems (GIS) data, and the like to estimate the destructive potential of a fire. The systems and methods may be integrated with many different types and combinations of external data, such as may be provided on an electronic network.

As used herein, reference to 770 nm may include 770 nm plus or minus 20 percent, or 10 percent, or 5 percent, or 1 percent. As used herein, reference to 770 nm may include 740-800 nm or 750-790 nm or 760-780 nm or 765-775 nm, or another range. Reference to 770 nm may include generally wavelengths shorter than 810 nm.

As used herein, reference to 810 nm may include 810 nm plus or minus 20 percent, or 10 percent, or 5 percent, or 1 percent. As used herein, reference to 810 nm may include 780-840 nm or 790-830 nm or 800-820 nm or 805-815 nm, or another range. Reference to 810 nm may include generally wavelengths longer than 770 nm.

One may also appreciate that the ranges for the different filters may be different. For instance, the 770 nm filter may be selected for association with optical emissions of fires containing certain combustibles, such as combustibles with significant potassium. At the same time, the 810 nm filter may be selected for association with optical emissions and/or reflections of background materials or other common features throughout an area being imaged in order to provide a common reference to compare images through the other filter(s) whereby a comparison reveals a presence or absence of fire.

The aforementioned “comparison” or a “determination” may be mentioned throughout in connection with identifying a presence or absence of fire. Such “comparisons” or “determinations” may be effectuated by one or more differential measurement. For example, in many embodiments, a differential measurement is performed where multiple images taken through multiple filters are compared. In further instances, this is different than evaluation of IR amplitude relative to background regions. More generally, a detection may be made by developing a spectral index derived from mathematically relating light in the two bands that is sensitive to the presence of fire. In some scenarios, such as remote sensing scenarios, differences, ratios, normalized differences (band 1−band 2) /(band 1+band 2) and other calculations may be performed. Moreover, comparison of images or determination of whether fire is present in one or more images may be referenced throughout this document. One may appreciate that the comparisons and/or determinations may be or may include one or more pixel-wise comparison of images, or a different type of comparison of images, or in further instances, may be a processing of underlying data not reduced to an image representation, or may be any further machine processing as desired. Thus use of the term “image” may also refer to underlying data corresponding to sensor outputs whether or not reduced to a file or representation conventionally associated with images. Further, while the disclosure is replete with references to “images” one may appreciate that “images” may also include video, multiple image frames, or other optical sensing data of different types and with and without a time-domain aspect.

Elaborating further on “compare” or “comparison, in various instances, images captured from different optical paths through a 770 nm filter and an 810 nm filter may first undergo image registration to align the images to a common scene. After registration, the reference images captured through the 770 nm and 810 nm filters may be combined using mathematical techniques, including but not limited to numerical differences, ratios, normalized ratios, or other comparative algorithms, to generate a feature image. This feature image may assist in identifying characteristic emissions associated with fires, such as sodium emissions, or such as potassium emissions. The feature image may then be processed through image pixel threshold detection, a trained support vector machine, or a deep neural network to generate outputs, such as bounding boxes or pixel masks, indicating the predicted presence or absence of brush fires. The bounding boxes or pixel masks may also include confidence values representing the model's prediction accuracy. In various instances, a system may have different physical architectures. In some instances, a single sensor may be used with single focusing element stack and a filter wheel that spins or otherwise alternates the filters in the image path. The filter wheel may be associated with an encoder. Moreover, different types of actuators apart from a filter wheel may be implemented. For instance, an actuator such as a linear actuator may operate to move a rectangular two-filter holder to alternate filters, or different types of actuators. Moreover, in various instances, filters may be not moved, but rather mirrors may be moved or otherwise implemented to facilitate an optical path including different filters. In various instances, a system may have multiple cameras fixed in different locations with a focusing element and filter associated with each. Via a bundle adjustment in software, hardcoding of pixel locations to spatial points, AI algorithm, or other method, relative positioning of pixels in the images of the different cameras may be determined and the pixels may be mapped so that the images can be compared accurately and precisely. In various instances, multiple cameras may be arbitrarily mounted and software such as an AI neural net or other method may ascertain relative positioning of pixels in the images of the different cameras to map the pixels so that the images can be compared accurately and precisely. Moreover, in various instances, a custom filter array may be on a camera with multiple filters associated with pixels so that a single camera has a single associated filter array to facilitate the comparative imaging. Various other configurations are also contemplated.

One configuration has spatially separated filters at the focal plane of a single camera (e.g., custom Bayer filters). A further fire detection system is offered. The system may include a first camera. The system may include a first focusing element in a first optical path of the first camera. The system may include two or more spectral filters affecting different pixels at the focalplane of the camera where the CMOS sensor is located, such that one set of pixels receives light filtered by the first filter and one set of pixels receives light filtered by the second filter. These filters at the focalplane may either be arranged in repeating mosaic blocks as in a Bayer filter, or in horizontal or vertical stripes as in a push-broom style filter. Various other configurations are also contemplated.

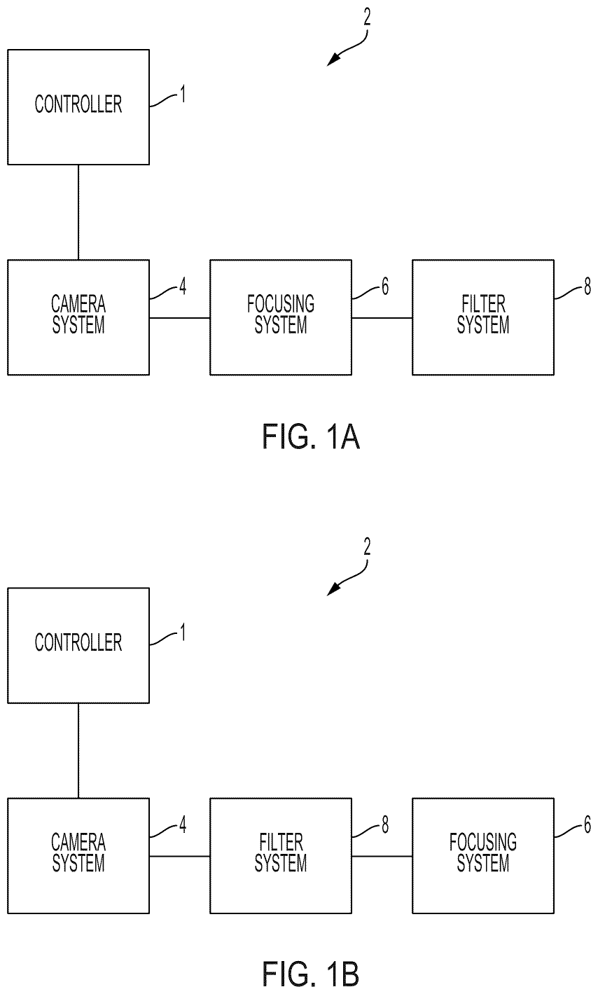

For instance, and now with reference to FIG. 1A, an example embodiment is illustrated. A fire detection system 2 may include a controller 1. The controller 1 may be a computer, a cloud computing system, an application specific integrated circuit (ASIC), a field programmable gate array (FPGA), a computer that is in electronic communication with other computing systems, or any other suitable controller. In various embodiments, some aspects of a controller may be locally connected to a camera system 4, such as for image collection, while other aspects of the controller may be remotely disposed, such as being a cloud resource for processing. The controller 1 may be connected to a camera system 4. The camera system 4 may include one camera, or two cameras, or any number of cameras as desired. The camera(s) may be visible light cameras. The camera(s) may be near-infrared cameras. The camera system 4 may include any suitable imaging device or devices as desired. The camera system 4 may be connected to a focusing system 6. The focusing system 6 may be structured and arranged to guide and/or focus light into camera(s) of the camera system 4. The focusing system 6 may include one or more focusing elements such as lenses and/or mirrors associated with a first camera of the camera system 4. In further instances, one or more mirrors may be associated with the first camera of the camera system 4, such as for a scanning mirror telescope implementation. The focusing system 6 may include one or more focusing element associated with a second camera of the camera system 4. The focusing system 6 may be connected to a filter system 8. The filter system 8 may include one or more filters so that different spectra of light may be isolated and evaluated to detect a fire. For instance, two filters may be included, as mentioned previously. Notably FIG. 1A illustrates an optical path where incident light passes through the filter system 8, then the focusing system 6, then to the camera system 4. Other configurations are possible. For instance, with reference to FIG. 1B, a fire detection system 2 may include similar components, but with different sequencing. For instance, an optical path may be provided wherein incident light passes through the focusing system 6, then the filter system 8, then to the camera system 4.

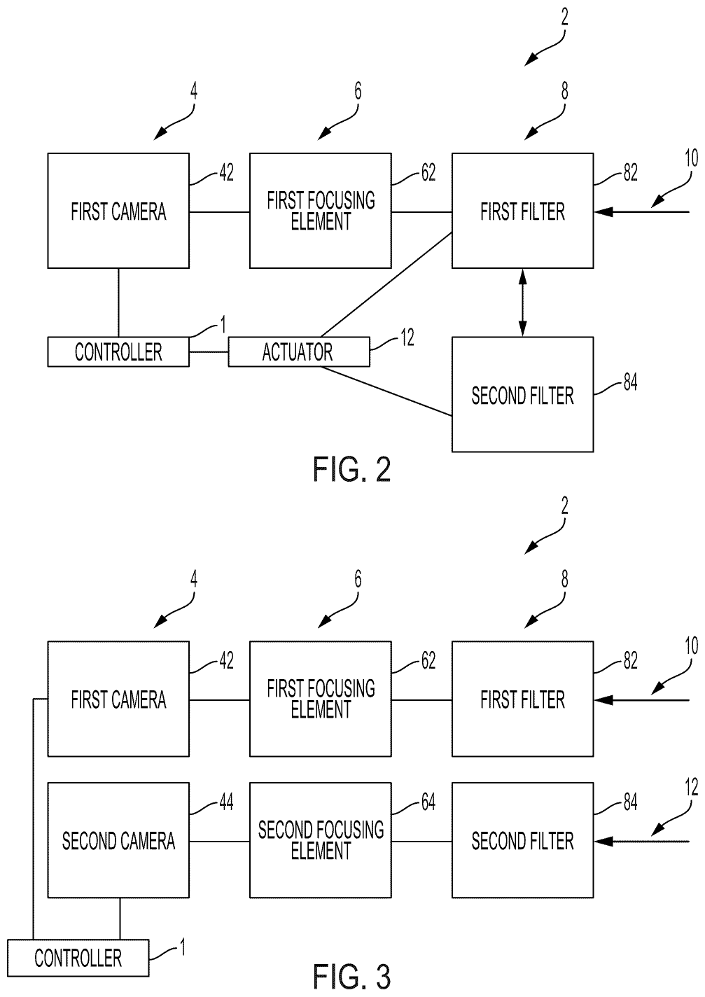

Referring now to FIG. 2, an example embodiment of the fire detection system 2 is illustrated. The controller 1 may be provided. The camera system 4 may include a first camera 42. The first camera 42 may be connected to the controller 1 and may provide image data to the controller 1. The first camera 42 may be connected to a focusing system 6. The focusing system 6 may include a first focusing element 62. The first focusing element 62 of the focusing system 6 may be connected to a filter system 8. The filter system 8 may include a first filter 82. The filter system 8 may also include a second filter 84. An actuator 14 may be connected to the controller 1 and may be operable by the controller 1 to change the first filter 82 and the second filter 84 into and out of a first optical path 10 into the filter system 8. In various instances the first optical path 10 passes through the filter system 8, the focusing system 6, and into the camera system 4. In various embodiments, the actuator 14 comprises an electrical motor, an encoder, an electrostatic or other device, a mirror and/or lens, or any mechanism for switching the first optical path 10 from passing through the first filter 82 to passing through the second filter 84 and vis-a-versa. In various instances, the first filter 82 and second filter 84 may have different center frequencies selected from among 770 nm and 810 nm. Different center frequencies may also be contemplated.

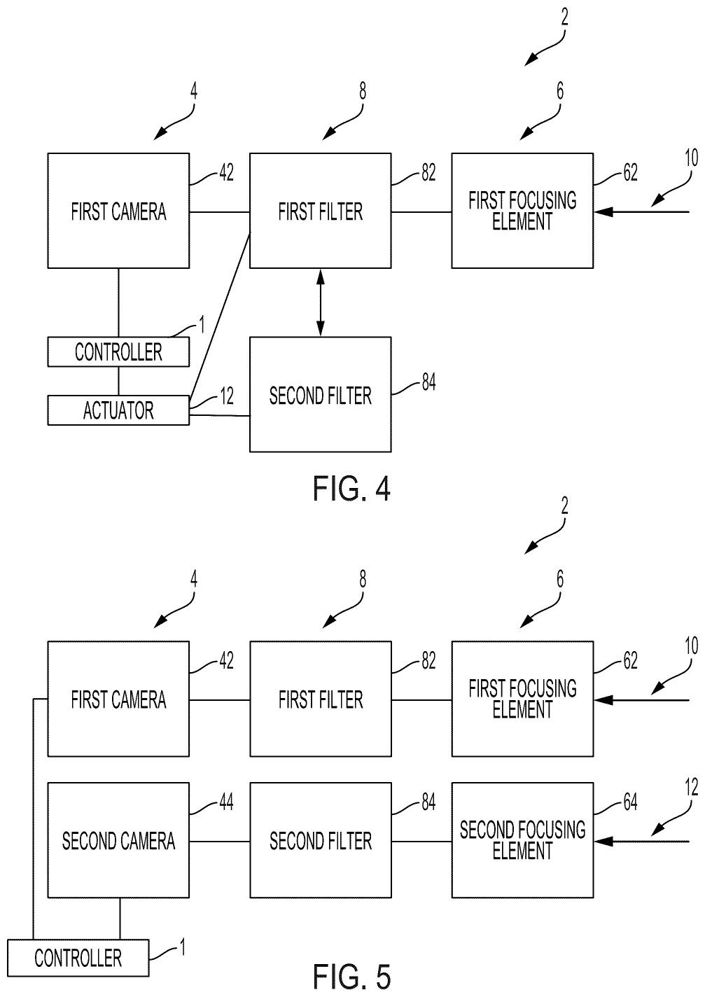

Referring now to FIG. 4, a similar system with similar reference numerals referring to similar features may be provided, except that the first optical path 10 illustrates the focusing system 6 and the filter system 8 in opposite order. Specifically, incident light passes along a first optical path 10 into the focusing system 6, then into the filter system 8, and to the first camera 42. Thus, for FIG. 4, an example embodiment of the fire detection system 2 is illustrated. The controller 1 may be provided. The camera system 4 may include a first camera 42. The first camera 42 may be connected to the controller 1 and may provide image data to the controller 1. The first camera 42 may be connected to filter system 8. The filter system 8 may include a first filter 82. The filter system 8 may also include a second filter 84. An actuator 14 may be connected to the controller 1 and may be operable by the controller 1 to change the first filter 82 and the second filter 84 into and out of a first optical path 10 into the filter system 8. The system may include a focusing system 6. The focusing system 6 may include a first focusing element 62. In various instances the first optical path 10 passes through the focusing system 6, the filter system 8, and into the camera system 4. In various embodiments, the actuator 14 comprises an electrical motor, an encoder, an electrostatic or other device, a mirror and/or lens, or any mechanism for switching the first optical path 10 from passing through the first filter 82 to passing through the second filter 84 and vis-a-versa. In various instances, the first filter 82 and second filter 84 may have different center frequencies selected from among 770 nm and 810 nm. Different center frequencies may also be contemplated.

Referring now to FIG. 3, another example embodiment of the fire detection system 2 is illustrated. The controller 1 may be provided. The camera system 4 may include a first camera 42 and a second camera 44. The first camera 42 may be connected to the controller 1 and may provide image data to the controller 1. The second camera 44 may be connected to the controller 1 and may provide image data to the controller 1. The first camera 42 may be connected to a focusing system 6. The second camera 44 may be connected to the focusing system 6. The focusing system 6 may include a first focusing element 62 associated with an optical path (first optical path 10) into the first camera 42. The focusing system 6 may include a second focusing element 64 associated with an optical path (second optical path 12) into the second camera 44. The first focusing element 62 of the focusing system 6 may be connected to a filter system 8. The second focusing element 64 of the focusing system 6 may be connected to the filter system 8. The filter system 8 may include a first filter 82. The filter system 8 may also include a second filter 84. The first filter 82 may be associated with the optical path (first optical path 10) of the first camera 42. The second filter 84 may be associated with the optical path (second optical path 12) of the second camera 44. For instance, a first optical path 10 may pass through the first filter 82, the first focusing element 62, and into the first camera 42. Similarly, a second optical path 12 may pass through the second filter 84, the second focusing element 64, and into the second camera 44. In various instances, the first filter 82 and second filter 84 may have different center frequencies selected from among 770 nm and 810 nm. Different center frequencies may also be contemplated.

Referring now to FIG. 5, a similar system with similar reference numerals referring to similar features may be provided, except that the first optical path 10 and the second optical path 12 both illustrate the focusing system 6 and the filter system 8 in opposite order. Specifically, incident light passes along a first optical path 10 into the focusing system 6, then into the filter system 8, and to the camera system 4. Incident light passes along a second optical path 12 into the focusing system 6, then into the filter system 8, and to the camera system 4. Thus, for FIG. 5, another example embodiment of the fire detection system 2 is illustrated. The controller 1 may be provided. The camera system 4 may include a first camera 42 and a second camera 44. The first camera 42 may be connected to the controller 1 and may provide image data to the controller 1. The second camera 44 may be connected to the controller 1 and may provide image data to the controller 1. The first camera 42 may be connected to a focusing system 6. The second camera 44 may be connected to the focusing system 6. The focusing system 6 may include a first focusing element 62 associated with an optical path (first optical path 10) into the first camera 42. The focusing system 6 may include a second focusing element 64 associated with an optical path (second optical path 12) into the second camera 44. The first focusing element 62 of the focusing system 6 may be connected to a filter system 8. The second focusing element 64 of the focusing system 6 may be connected to the filter system 8. The filter system 8 may include a first filter 82. The filter system 8 may also include a second filter 84. The first filter 82 may be associated with the optical path (first optical path 10) of the first camera 42. The second filter 84 may be associated with the optical path (second optical path 12) of the second camera 44. For instance, a first optical path 10 may pass through the first focusing element 62, first filter 82, and into the first camera 42. Similarly, a second optical path 12 may pass through the second focusing element 64, second filter 84, and into the second camera 44. In various instances, the first filter 82 and second filter 84 may have different center frequencies selected from among 770 nm and 810 nm. Different center frequencies may also be contemplated.

The first filter 82 may be called a “first filter” for convenience but actually may be made of multiple filter elements. For instance, multiple filter elements may affect different pixels of the sensor focalplane. Thus, not only may there be two cameras with two filters, and one camera with two or more changeable filters, but there may be one camera with multiple filters that affect different pixels of the sensor focal plane. For instance, first camera 42 may have first filter 82 which is actually multiple filter elements that affect different pixels of the first camera 42 focal plane. Second optical path 12 may be omitted. In further instances, second optical path 12 is not omitted and similarly the second filter 84 associated with the second camera 44 may actually be made of multiple filter elements, so that different filter elements affect different pixels of the sensor focal plane. In each instance, the different filter elements may have different center frequencies selected from among 770 nm and 810 nm. Different center frequencies may also be contemplated.

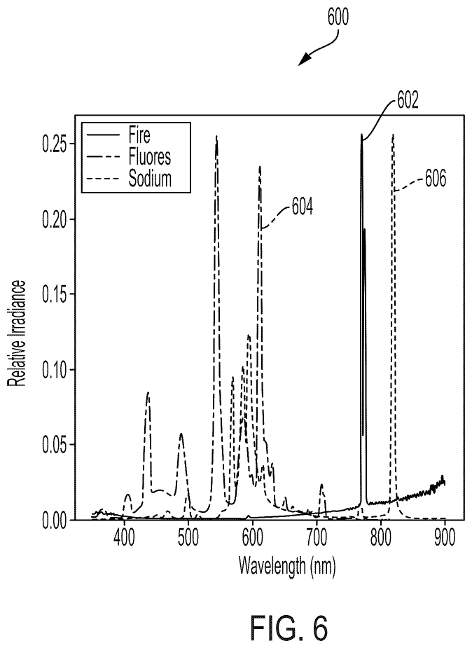

Turning now to FIG. 6, an example graph 600 illustrating different spectra of light is shown. The graph 600 shows relative irradiance on a Y axis and wavelength (nm) on an X axis. The graph 600 illustrates the emitted light associated with fire 602, fluorescence 604, and sodium 606. As shown, fire 602 illustrates a local peak at about 770 nm, as discussed in the prior paragraphs. By appropriate filtering, this relative irradiance peak may be detected, and located within an image, to facilitate fire detection and fire location.

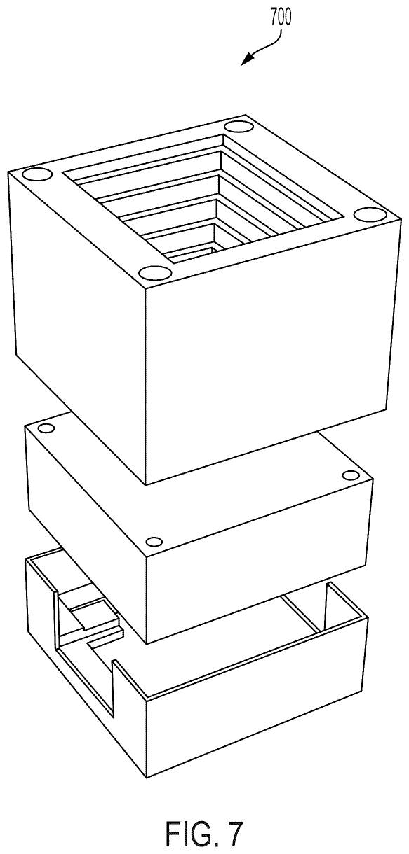

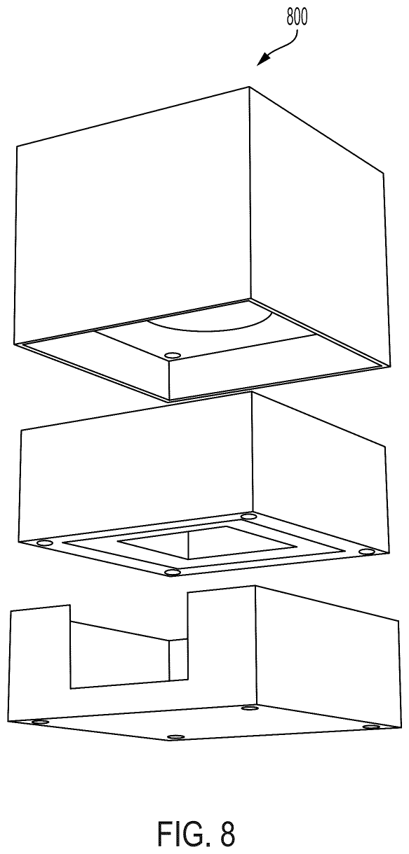

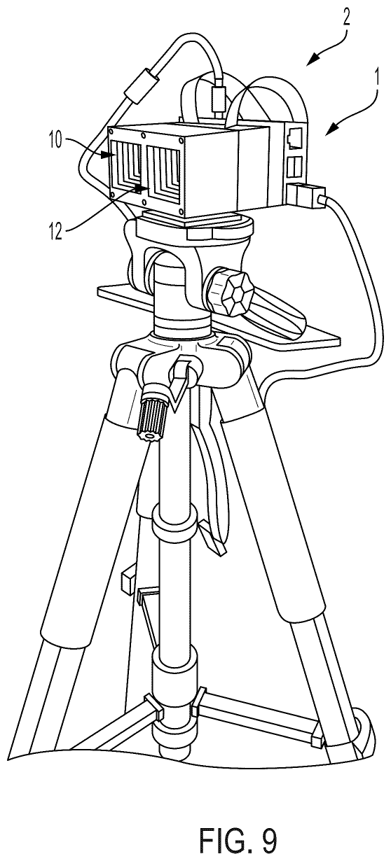

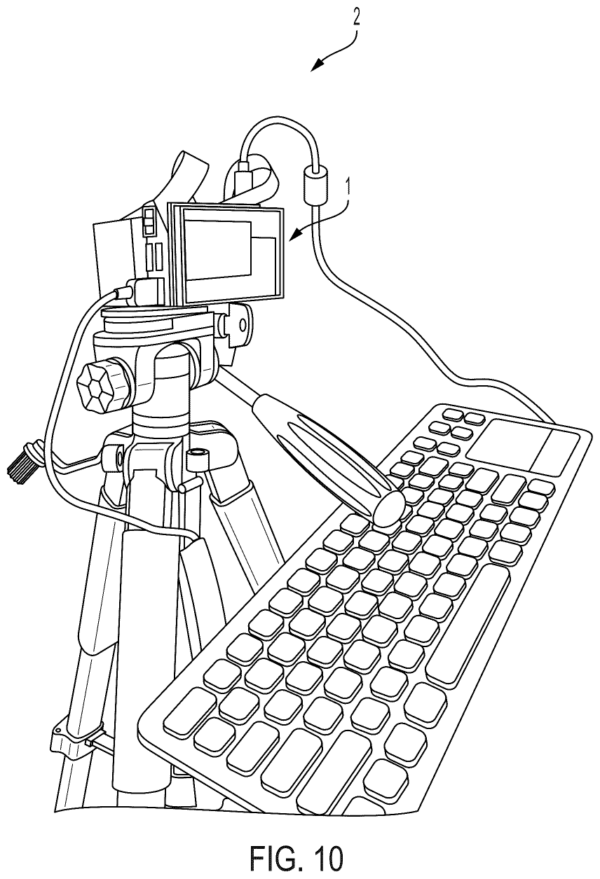

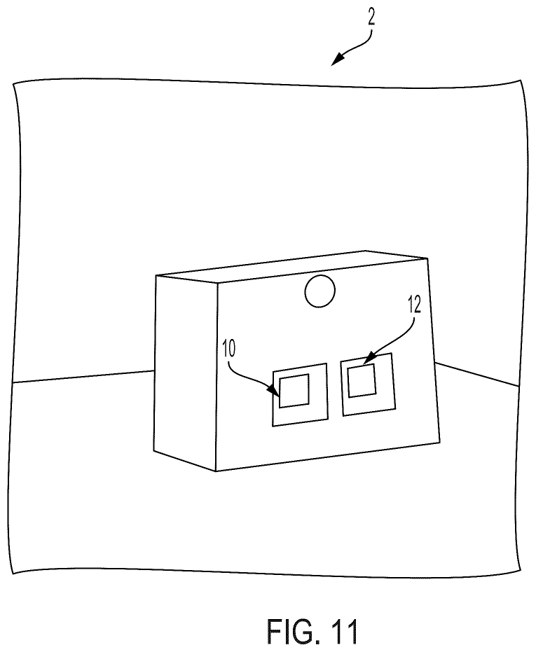

Turning now to FIG. 7, an illustration 700 of an example enclosure for a fire detection system 2 (FIG. 1) as discussed herein may be provided. Turning now to FIG. 8, a further illustration 800 of an example enclosure for a fire detection system 2 (FIG. 1) as discussed herein may be provided. FIGS. 9 and 10 show an example embodiment of a fire detection system 2 having a first optical path 10 and a second optical path 12, with a controller 1, mounted together in a compact package. FIG. 11 shows an example embodiment of a fire detection system 2 in an enclosure of FIGS. 7 and 8 and showing the first optical path 10 and the second optical path 12.

Thus, referring to the collection of FIGS. 1-8, different example embodiments are provided herein. For instance, a fire detection system 2 may include a camera system 4. The camera system 4 may have at least one camera having an associated at least one optical path. The fire detection system 2 may include a focusing system 6. The focusing system 6 may include at least one focusing element in the at least one optical path of the at least one camera. The fire detection system 2 may include a filter system 8. The filter system 8 may include at least (i) a first filter 82 having a first center frequency and first passband and (ii) a second filter 84 having a second center frequency and second passband. Moreover, the fire detection system 2 may include a controller 1. The controller 1 may be configured to compare (iii) a first image captured by the camera system 4 through the at least one optical path including the first filter 82 and not the second filter 84 and (iv) a second image captured by the camera system 4 through the at least one optical path including the second filter 84 and not the first filter 82, to determine a presence or absence of a fire.

In various embodiments, the first center frequency is 770 nm and the second center frequency is 810 nm. In various embodiments, the first passband and the second passband have a same bandwidth. In further embodiments, the first passband and the second passband may have different bandwidths. In various embodiments the first center frequency and first passband are associated with a first spectral range between 760 and 780 nm and the second center frequency and second passband are associated with a reference band within plus or minus 40 nm of the first spectral range.

A further fire detection system 2 is offered. The fire detection system 2 may include a first camera 42. The fire detection system 2 may include a first focusing element 62 in a first optical path 10 of the first camera 42. The fire detection system 2 may include a first filter 82 and a second filter 84. In various embodiments, the first filter 82 and the second filter 84 are selectably insertable by an actuator 14 into the first optical path 10. The fire detection system 2 may include a controller 1 connected to the first camera 42 and configured to capture a first image by the first camera 42 through the first focusing element 62 and the first filter 82 and configured to capture a second image by the first camera 42 through the first focusing element 62 and the second filter 84. A presence of a fire is detectable by comparing the first image and the second image, such as by the controller 1. For the avoidance of doubt, one may appreciate that the comparison may be a pixel-wise comparison of images or may be a different type of comparison of images, or in further instances, may be a processing of underlying data not reduced to an image representation, or may be any further machine processing as desired.

In various embodiments, the first filter 82 has a first center frequency of 770 nm and the second filter 84 has a second center frequency of 810 nm.

A yet further fire detection system 2 is contemplated. The fire detection system 2 may include a first camera 42. The fire detection system 2 may include a second camera 44. The system may include a first focusing element 62 in a first optical path 10 of the first camera 42. The fire detection system 2 may include a second focusing element 64 in a second optical path 12 of the second camera 44. The fire detection system 2 may include a first filter 82 in the first optical path 10 of the first camera 42. The fire detection system 2 may include a second filter 84 in the second optical path 12 of the second camera 44. In various embodiments, the first camera 42 and the second camera 44 are connectable to a controller 1 such as a fire detection controller for detecting a fire.

The fire detection system 2 may include the controller 1 so that the fire detection controller is connected to the first camera 42 and the second camera 44 and configured to compare a first image collected by the first camera 42 through the first optical path 10 and a second image collected by the second camera 44 through the second optical path 12.

In various embodiments, the first filter 82 has a first center frequency of 770 nm and the second filter 84 has a second center frequency of 810 nm.

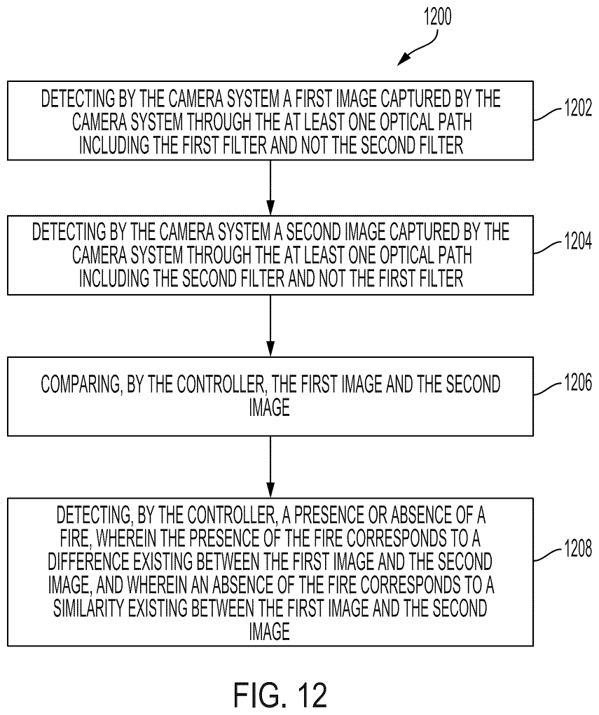

Turning now to FIG. 12, a method 1200 of fire detection is provided. The method 1200 may be a method of fire detection by a fire detection system comprising (a) a camera system comprising at least one camera having an associated at least one optical path; (b) a focusing system comprising at least one focusing element in the at least one optical path of the at least one camera; (c) a filter system comprising at least (i) a first filter having a first center frequency and first passband and (ii) a second filter having a second center frequency and second passband; and (d) a controller. The method 1200 may include detecting by the camera system a first image captured by the camera system through the at least one optical path including the first filter and not the second filter (block 1202). The method may include detecting by the camera system a second image captured by the camera system through the at least one optical path including the second filter and not the first filter (block 1204). The method may include comparing, by the controller, the first image and the second image (block 1206). The method may include determining, by the controller, a presence or absence of a fire, wherein the presence of the fire corresponds to a difference existing between the first image and the second image, and wherein an absence of the fire corresponds to a similarity existing between the first image and the second image (block 1208). In various embodiments of the method, the controller includes an artificial intelligence engine having a plurality of neural nets configured to perform the determining. As used herein, “similarity” and “difference” may correspond to various physical or electromagnetic properties. In various embodiments, different properties may be of interest. For example, in some instances, there are ground materials, such as bare soil, which may show a difference existing between the images, but with an oppositely-directed difference than what one would expect for a present fire. For instance, bare ground may show a higher solar reflectance in an image associated with an 810 nm filter than in an image associated with a 770 nm filter. In various instances, bare ground may show a difference of a lower magnitude than expected from a fire. Thus, use of the word “difference” may correspond to a difference of a certain magnitude and direction that would correspond to a presence of a fire. An absence of a fire fails to meet either the direction, or the magnitude, or both, and this corresponds to a “similarity” rather than a “difference.”

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S. C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A fire detection system comprising:
a camera system comprising at least one camera having associated an at least one optical path;
a focusing system comprising at least one focusing element in the at least one optical path of the at least one camera;
a filter system comprising at least (i) a first filter having a first center frequency and first passband and (ii) a second filter having a second center frequency and second passband; and
a controller configured to compare (iii) a first image captured by the camera system through the at least one optical path including the first filter and not the second filter and (iv) a second image captured by the camera system through the at least one optical path including the second filter and not the first filter, to determine a presence or absence of a fire.

2. The fire detection system of claim 1, wherein the first center frequency is 770 nm and the second center frequency is 810 nm.

3. The fire detection system of claim 1, wherein the first center frequency and first passband are associated with a first spectral range between 760 and 780 nm and wherein the second center frequency and second passband are associated with a reference band within plus or minus 40 nm of the first spectral range.

4. The fire detection system of claim 2, wherein the first passband and the second passband have a same bandwidth.

5. The fire detection system of claim 1, wherein the first filter and the second filter are filter elements of a same filter, the filter elements affecting different pixels in a sensor focalplane of a same camera of the camera system.

6. A fire detection system comprising:
a first camera;
a first focusing element in a first optical path of the first camera;
a first filter and a second filter,
wherein the first filter and the second filter are insertable into the first optical path; and
a controller connected to the first camera and configured to capture a first image by the first camera through the first focusing element and the first filter and configured to capture a second image by the first camera through the first focusing element and the second filter, wherein a presence of a fire is detectable by comparing the first image and the second image.

7. The fire detection system of claim 6, wherein the first filter and the second filter are selectably insertable by an actuator into the first optical path.

8. The fire detection system of claim 6, wherein the first filter and the second filter comprise different filter elements of a same filter, the different filter elements affecting different pixels of a sensor focalplane of the first camera.

9. The fire detection system of claim 6, wherein the first filter has a first center frequency of nm and the second filter has a second center frequency of 810 nm.

10. A fire detection system comprising:
a first camera;
a second camera;
a first focusing element in a first optical path of the first camera;
a second focusing element in a second optical path of the second camera;
a first filter in the first optical path of the first camera; and
a second filter in the second optical path of the second camera,
wherein the first camera and the second camera are connectable to a controller for detecting a fire.

11. The fire detection system of claim 10, further comprising the controller, the controller connected to the first camera and the second camera and configured to compare a first image collected by the first camera through the first optical path and a second image collected by the second camera through the second optical path.

12. The fire detection system of claim 10, wherein the first filter has a first center frequency of 770 nm and the second filter has a second center frequency of 810 nm.

13. A method of fire detection by a fire detection system comprising (a) a camera system comprising at least one camera having associated an at least one optical path; (b) a focusing system comprising at least one focusing element in the at least one optical path of the at least one camera; (c) a filter system comprising at least (i) a first filter having a first center frequency and first passband and (ii) a second filter having a second center frequency and second passband; and (d) a controller, the method comprising:
detecting by the camera system a first image captured by the camera system through the at least one optical path including the first filter and not the second filter;
detecting by the camera system a second image captured by the camera system through the at least one optical path including the second filter and not the first filter;
comparing, by the controller, the first image and the second image; and
determining, by the controller, a presence or an absence of a fire, wherein the presence of the fire corresponds to a difference existing between the first image and the second image, and wherein the absence of the fire corresponds to a similarity existing between the first image and the second image.

14. The method according to claim 13, wherein the controller includes an artificial intelligence engine having a plurality of neural nets configured to perform the determining.

15. The method according to claim 13, wherein the first filter and the second filter are filter elements of a same filter, the filter elements affecting different pixels in a sensor focalplane of a same camera of the camera system.

16. A fire detection system comprising:
a camera system comprising at least one camera having associated an at least one optical path;
a focusing system comprising at least one focusing element in the at least one optical path of the at least one camera;
a filter system comprising at least (i) a first filter having a first center frequency and first passband and (ii) a second filter having a second center frequency and second passband; and
a controller configured to compare (iii) a first image captured by the camera system through the at least one optical path including the first filter and not the second filter and (iv) a second image captured by the camera system through the at least one optical path including the second filter and not the first filter, to determine a presence or absence of a fire,
wherein the fire detection system at least one of (1) further includes and (2) is in electronic communication with a further camera, and the controller performs sensor fusion with data corresponding to an additional optical band of the further camera.

17. The system of claim 16, wherein the further camera is a longwave infrared camera.

18. The system of claim 16, wherein the further camera is a medium wave infrared camera.

19. The system of claim 16, wherein the further camera is a short wave infrared camera.

20. The system of claim 16, wherein the first filter and the second filter are filter elements of a same filter, the filter elements affecting different pixels in a sensor focalplane of a same camera of the camera system.
